(19) United States
(12) Patent Application Publication
(10) Pub. No.: US 2006/0064738 A1
(43) Pub. Date: Mar. 23, 2006

(54) Device usage information writing apparatus and method thereof, image forming apparatus and device system having the apparatus

(75) Inventors: Hideki Hino, Toyokawa-shi (JP); Toru Ichiki, Sagamihara-shi (JP); Hiroshi Iwamoto, Toyohashi-shi (JP); Masaaki Saka, Toyokawa-shi (JP); Shoji Imaizumi, Shinshiro-shi (JP); Eiichi Yoshida, Toyokawa-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/023,406

(22) Filed: Dec. 29, 2004

(30) Foreign Application Priority Data
Sep. 21, 2004 (JP) 2004-273892

(51) Int. Cl. H04L 9/32

(52) U.S. Cl. 726/2

(57) ABSTRACT

A device usage information writing apparatus comprises a memory having a usage information storage area wherein the usage information of a job execution device of a user is stored with reference to the user; a determination part of an existence of area wherein the existence of the usage information storage area regarding the user is determined concerning the existence at the memory when the user who has succeeded an authentication at an authentication part uses the device; an area generation part wherein the usage information storage area is generated with reference to the user when the determination part of the existence of area determines that the usage information storage area does not exist after the determination process at the determination part of the existence of the area; and a writing part in which the device usage information of the user is written in the usage information storage area generated by the area generation part or in an already-existing usage information storage area.

This application claims priority under 35 U.S.C. § 119 to Japanese Patent Application No. P2004-273892 filed on Sep. 21, 2004, the entire disclosure of which is incorporated herein by reference in its entirety.

### BACKGROUND OF THE INVENTION

1. Field of the Invention

The present invention relates to a device usage information writing apparatus and method thereof, image forming apparatus and device system having the apparatus for writing the usage information to a memory when a user uses a device such as an image forming apparatus.

2. Description of Related Art

When the image forming apparatus provided with at least one function of copying, scanning, printing, and faxing, such as a copier, a printer, and a facsimile, or a MFP (Multi Function Peripherals) that functions with varying combinations of the above is used by a plurality of users, in order to manage the user information including a number of papers used for the copier or the printer, U.S. Pat. No. 6,535,297 discloses the image forming apparatus in which an authentication code is provided with each user at the first time of their use and only authentication is required for their use afterwards.

In this image forming apparatus, a usage information storing area for storing the usage information with reference to each user is formed in a memory device. Information for users who succeeded to obtain the authentication is written in a corresponding user information storing area.

In the conventional image forming apparatus described above, however, when there is a new user with has obtained an authentication code the administrator should handle a complicated procedure to generate a new usage information storing area in the memory device with reference to the user for storing the usage information.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a device usage information writing apparatus that can eliminate the need for administrator to conduct a formation process of the usage information storing area when there is new user having the new authentication code.

Among other potential advantages, some embodiments can provide a image forming apparatus having the writing apparatus shown above.

Among other potential advantages, some embodiments can provide a device system having the writing apparatus shown above.

Among other potential advantages, some embodiments can provide a method for writing device usage information that requires no generation process of the usage information storage area in a case where there is new user having the new authentication code.

According to a first aspect of a preferred embodiment of the present invention, a device usage information writing apparatus, comprises:
a memory having a usage information storage area wherein usage information of a job execution device by a user is stored with reference to the user;
a determination part of the existence of an area wherein the existence of the usage information storage area regarding the user is determined concerning the existence at the memory when the user who has succeeded an authentication at an authentication part uses the apparatus;
an area generation part wherein the usage information storage area is generated with reference to the user when the determination part of the existence of area determines that the usage information storage area does not exist after the determination process at the determination part of the existence of the area; and
a writing part wherein the device usage information by the user is written in usage information storage area generated by the area generation part or in an already-existing usage information storage area.

According to a second aspect of a preferred embodiment of the present invention, an image forming apparatus having any of a copying function, a scanning function, a printer function, and a facsimile function, comprises:
a memory having a usage information storage area wherein usage information of the image forming apparatus by a user is stored with reference to the user;
a determination part of an existence of an area wherein an existence of the usage information storage area regarding the user is determined concerning the existence at the memory when the user who has succeeded an authentication at an authentication part uses the apparatus;
an area generation part wherein the usage information storage area is generated with reference to the user when the determination part of the existence of the area determined that the usage information storage area does not exist after a determination process at the determination part of the existence of the area; and
a writing part wherein the usage information of the user is written in the usage information storage area generated by the area generation part or in an already-existing usage information storage area.

According to a third aspect of a preferred embodiment of the present invention, a device system, comprises:
a job execution device;
an authentication apparatus for authenticating a user who uses the device;
a memory having a usage information storage area in which device usage information of the job execution device by the user is stored in association with the user; and
a usage information writing apparatus,
wherein the usage information writing apparatus comprises a determination part of the existence of the area wherein the existence of the usage information storage area regarding the user is determined concerning the existence at the memory when the user who has succeeded an authentication at an authentication part uses the apparatus;
an area generation part wherein the usage information storage area is generated with reference to the user when the determination part of the existence of the area determines that the usage information storage area does not exist after the determination process at the determination part of the existence of the area; and
a writing part wherein the usage information by the user is written either in the usage information storage area generated by the area generation part or in an already-existing usage information storage area.

According to a fourth aspect of a preferred embodiment of the present invention, a device usage information writing method, comprises the steps of:
authenticating a user who uses a job execution device;
determining an existence of a usage information storage area in a memory regarding the user when the user who has succeeded an authentication uses the device;
generating the usage information storage area with reference to the user when the information storage area is determined as not being existed; and
writing device usage information of the user into the generated usage information storage area or into an already-existing usage information storage area.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a configuration diagram of the image forming system using a MFP having the usage information writing apparatus of an embodiment of the present invention;

FIG. 2 is a block diagram showing a schematic configuration of the MFP in FIG. 1;

FIGS. 3A-3D are diagrams illustrating a user information registration area and a usage information storage area in the memory of the MFP shown in FIG. 2;

FIG. 4A is a diagram showing a printing setting display of a user terminal when the printing job is sent;

FIG. 4B is a diagram showing an input display for an authentication data;

FIG. 5 is a flowchart of a job reception process conducted by a controller of the MFP in the system shown in FIG. 1;

FIG. 6 shows a system wherein a plurality of the MFPs and print servers are connected to the user terminal or the authentication server through a network; and

FIG. 7 is a flowchart showing a content of the job reception process conducted by the controller of the MFP or a printing controller.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

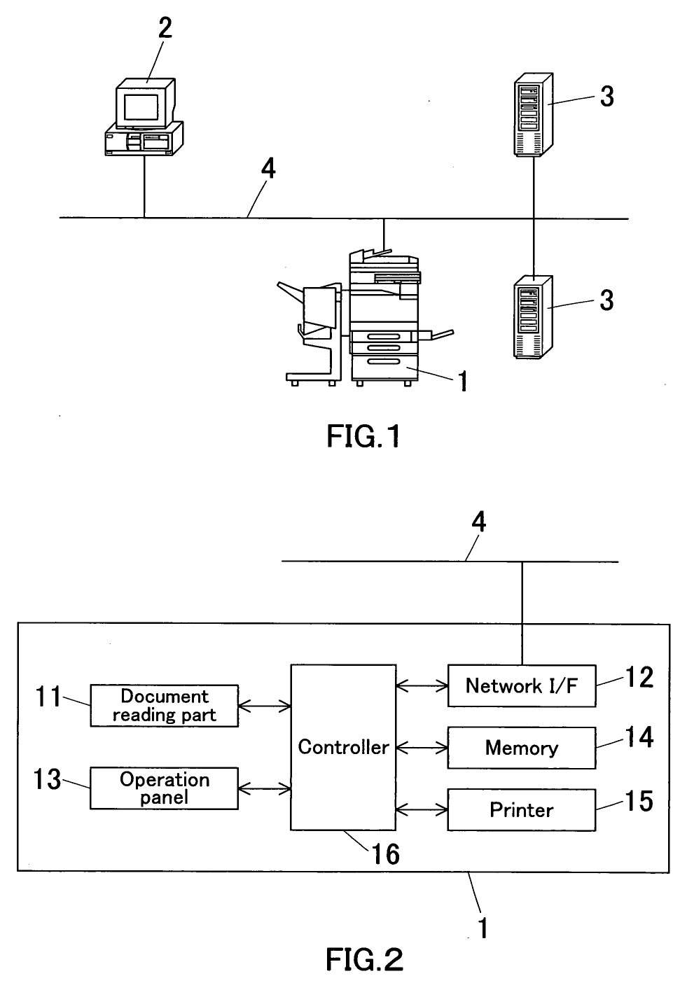

FIG. 1 is a configuration diagram of the image forming system using the MFP provided with the usage information writing apparatus of an embodiment of the present invention.

In the system of FIG. 1, a reference numeral 1 denotes the MFP as an image forming apparatus, a reference numeral 2 denotes the user terminal comprised of personal computer or such, a reference numeral 3 denotes one or more authentication servers mounted outside the MFP1, and these MFP1, user terminal 2, and authentication servers 3 are connected through a network 4.

FIG. 2 shows a schematic configuration of the MFP 1. The MFP 1 comprises a document reading part 11, a network interface part 12 (referred to as a I/F in the drawings), a operation panel 13, a memory 14, a printer 15, and a controller 16.

The document reading part 11 reads the image on the document placed on the document base (not shown) and sends the image data.

The network interface part 12 functions as a sending and receiving part of the data among the user terminal 2, the authentication server 3, and other peripherals.

The operation panel 13 comprises a variety of manipulation keys such as a mode setting key, a start button, a ten key pad, etc, and a touch panel display of liquid crystal, etc, to be operated during the use of the MFP 1 or mode setting.

The memory 14 is an involatile memory wherein information is saved even if the power source of the apparatus is turned off and includes a hard disc for example. The memory 14 not only stores the read image data of the document read at the document reading part and the sending address of the image data, but also stores user information, and further stores the usage information of the user using the MFP1 with reference to the user information with each user. For this, the memory 14 comprises a user information registration area, and the usage information storage area with reference to the user information registered in the user information registration area.

The printer 15 prints the image data of a document read at the document reading part 11, or a print data sent from the user terminal 2.

The controller 16 comprises a CPU and controls the entire operation of the MFP1. Specifically, the controller 16 controls the document reading part 11 to read the document image based upon the start instruction of the user, controls the memory 14 to store the read image data, controls the printer 15 to print the image data or controls the network interface 12 to send to the peripherals. Additionally, in the use of the MFP1, when the authentication data is input for the user authentication from the user terminal 2 or the operation panel 13, the controller send a data to the authentication server 3 for the execution of the authentication.

Moreover, in this embodiment, the controller 16 functions as a determination part for the existence of the area, an area generation part, and a writing part.

More specifically, the controller 16 determines whether the usage information storage area regarding the user already exists in the memory 14 when the user authentication is succeed by the authentication server 3. When the area does not exist, the controller 16 generates the usage information storage area with reference to the user. And according to a specific embodiment of the usage of the MFP1 by the user, the usage information is written in the generated usage information storage area or an already existing usage information storage area. The further detail will be described later.

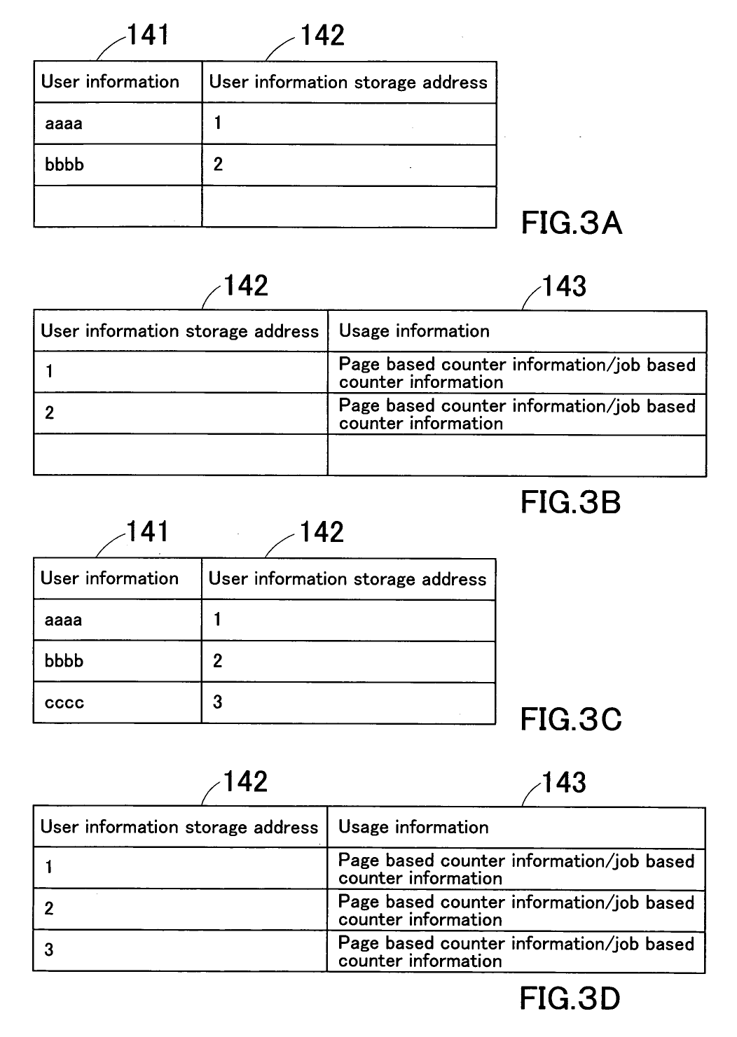

FIG. 3 describes a corresponding relationship of the user information registration area in the memory 14 and the user usage information storage area.

As shown in FIG. 3A, a user name as user information shown as a user ID and such is registered in the user information registration area 141. In FIG. 3A, a user “aaaa” and a user “bbbb” is registered, and each user is associated with a usage information storage address 142 that shows a usage information storage area.

As shown in FIG. 3B, usage information of the user using the MFP1 is stored at the usage information storage area 143 shown with the usage information storage address 142 with reference to each user. In this embodiment, a page based counter information and a job based counter information is stored as a usage information in using of a copying function, a printing function, a scanning function, and a facsimile function (hereinafter referred to as a FAX) as a function of the MFP1.

More specifically, the copying function is a function in which the image data of the document read by the document reading part 11 is printed to the paper at printer 15, and the scanning function is a function in which the image data of the document read at the document reading part 11 or the data sent from the user terminal 2 is sent to a predetermined destination in a sending form such as an e-mail, or a FTP (File Transfer Protocol). The printing function prints a printing data sent from the user terminal etc onto a paper at the printer 15, and the FAX function sends the image data of the document read at the document reading part 11 to the destination through a telephone line.

Specific examples of the page base counter comprises: a total counter for copying in use of the copying function (the total colors/black/full colors/monotone/2 colors), a counter for large size copying (the total colors/black/full colors/monotone/2 colors), a total counter for printing in use of the printing function (the total colors/black/full colors/monotone/2 colors), a counter for large size printing (the total colors/black/full colors/monotone/2 colors), a total counter that is a combination of the copying function and the printing function (the total colors/black/full colors/monotone/2 colors), a total counter for large size (the total colors/black/full colors/monotone/2 colors), a total counter for scanning/FAX reading in the use of the scanning function and the FAX function, a large size counter for scanning/FAX reading, or a counter for number of FAX sending, a total counter for scanning/FAX prints, a counter for large size scanning/FAX prints, a counter for number of documents, and a counter for number of papers.

Specific example of the job base counter comprises: a job counter for inter sheets, a job counter for confidential documents, a job counter for verification printing, a job counter for a box saving, a job counter for stapling, a job counter for punching, a job counter for making a pamphlet, a job counter for stapling direction, a job counter for control number, a job counter for a water mark, and a job counter for forming over lay.

A new user who is not registered in the user information registration area 141, as shown in FIGS. 3(C) and 3(D), requires a new registration (storing) at the user information registration area 141 (a user “cccc” is newly registered), and the usage information storage area 143 is generated with reference to the user to write the usage information in the generated usage information storage area when the user uses a function of the MFP1.

The image forming system shown in FIG. 1 sends a printing data from the user terminal 2 to the MFP1 along with an authentication data in a case where the data prepared at the user terminal 2 is printed at the MFP1, for example.

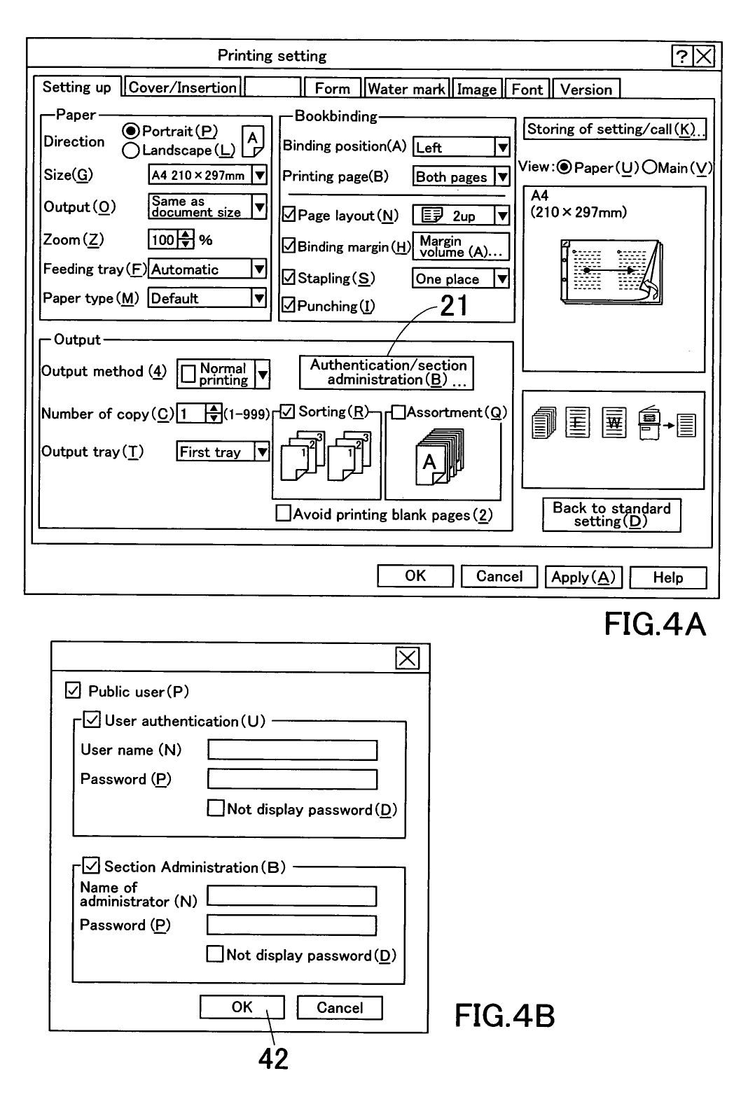

FIG. 4A shows a screen for printer setting by a printer driver shown in a display of the user terminal 2. In this screen for printer setting, an authentication button 21 is displayed for the authentication along with other items of input data such as output paper settings and output method. When the authentication button 21 is depressed, an authentication input screen appears as shown in FIG. 4(B) to input a name of the user(user ID), a user password, a name of a section administration(section ID), and a section password.

Upon input of the predetermined items, OK button 42 is depressed to send a printing job comprising a printing data and an authentication data such as the user name and a password.

The use of scanning function of the MFP1 also sends authentication data along with scanning job to the MFP1.

The MFP1 that received the job and the authentication data from the user terminal 2 sends the authentication data to the authentication server 3 to instruct the authentication. The authentication server 3 compares the received authentication data with a data stored in the database inside the server 3, and returns a result of the authentication to the MFP1.

When a plurality of authentication servers 3 authenticate in liaison with each other, their settings may be in such a way that succeeded authentication by any one of the authentication servers 3 automatically provides an authentication to the rest of the server. Or the settings may be limited in such a way that the authentication can be assured only when the entire server obtained authentication.

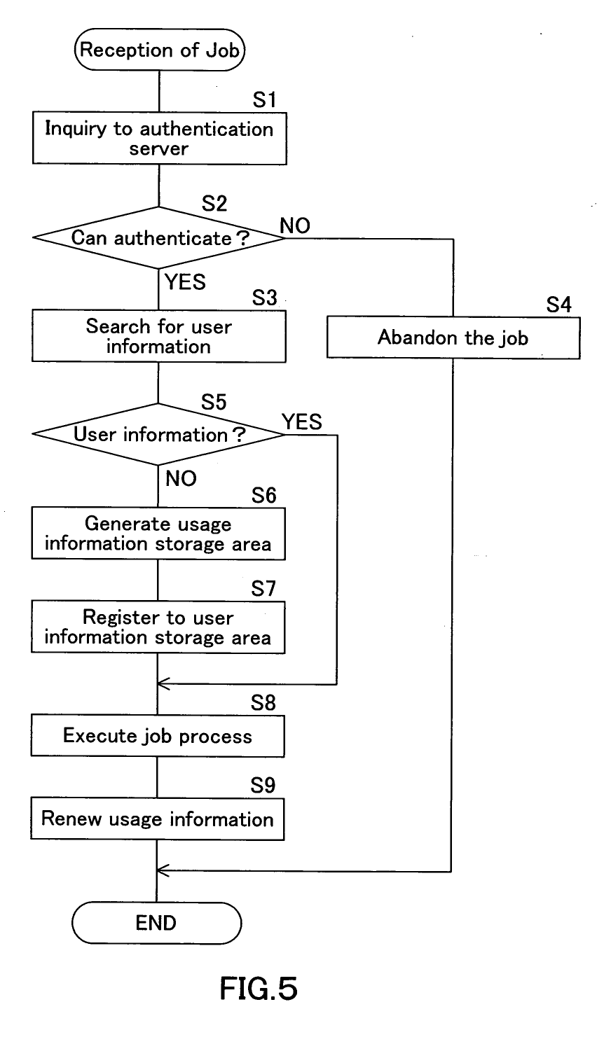

FIG. 5 is a flowchart showing a content of job reception process at the controller 16 of the MFP1 when the MFP1 receives the job and the authentication data from the user terminal 2. Each step will be referred to as a “S” in the below descriptions and drawings.

The controller 16 sends the authentication data to the server 3 to make an inquiry about the authentication at the S1.

The controller 16 then determines whether a inquiry result from the server 3 obtains an authentication or not at the S2. If the authentication succeeds, the user information registered in the memory 14 is searched at the S3 to determine whether the usage information storage area for the user 143 exists or not at the S3. If the authentication fails, (when the S2 determines NO) the job is abandoned at the S4 and the process is terminated. The failure of the authentication may be sent to and displayed at the terminal 2.

Upon the searching, the controller 16 determines whether the user information has already been registered or not in the S5, that is to determine whether the usage information storage area 143 has already been existed. As no registration (when the S5 determines “none”) means that the user is new, the usage information storage area 143 is generated at the S6, and user information is registered in the user information registration area 141 at the S7. The process then moves to the S8. At this point, the order is such that an usage information storage area 143 may be generated upon the registration at the user information registration area 141.

When the user information is registered (when the S5 determines “exist”), as this means that the user is not new and the usage information storage area 143 has already generated, the process then proceeds to the S8.

The S8 executes a process of a job specified by the user. The S9 writes the usage information to renew the contents at a newly generated or the already existed usage information storage area 143 to terminate the job reception process.

In this embodiment, the usage information is written after the execution of the job process, however, there can be a case wherein the information is written prior to or at some midpoint of the process according to the contents of the usage information.

As for the new user, information storage area 143 with reference to the user information is automatically generated. This eliminates the need for administrator to conduct a complicated formation process of the usage information storing area 143 for new user.

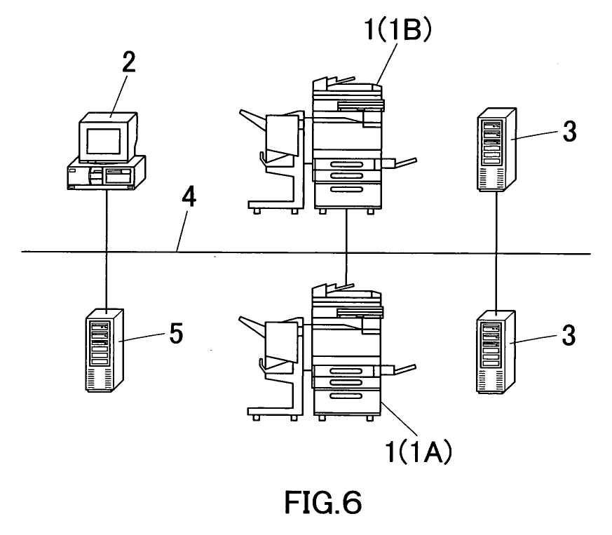

FIG. 6 shows a system in which a plurality of MFPLA, MFP1B and print server 5 are connected to the user terminal 2 or the authentication server 3 through the network 4. One of the MFP1 may have a print server function. A plurality of MFP1A, MFP1B is set as a group by the print server 5.

The configuration of the MFP1A, MFP1B is similar to the one shown in FIG. 2. In this embodiment, the user information registration area 141 and the corresponding usage information storage area 143 for all of the MFP1A, MFP1B are generated in memory part 14 of the MFP1B. That is, all of the MFP1A and MFP1B share one memory part 14 that is provided in MFP1B with regard to the user information registration area 141 and usage information storage area 143. In the print server 5, the location of the memory part 14, wherein the user information registration area 141 and usage information storage area 143 is generated, is previously registered.

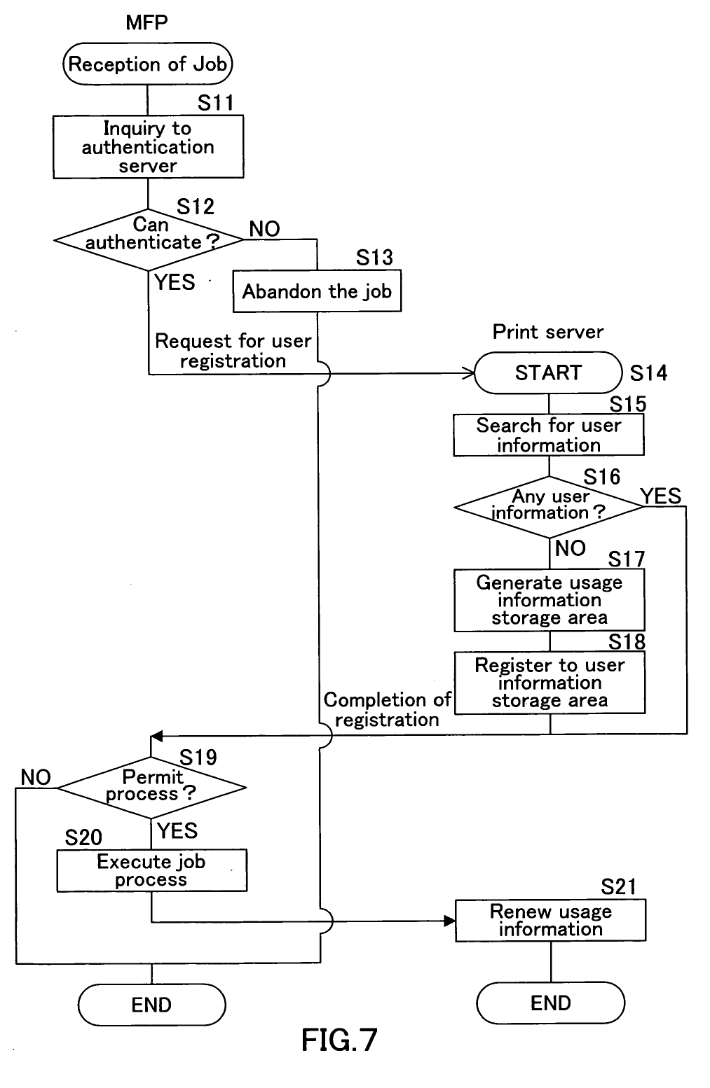

FIG. 7 is a flowchart showing a content of the job reception process conducted by controller 16 of the MFP1A and controller 5 when the MFP1A receives a job or the authentication data from the user terminal 2 through a print controller 5 in the system shown in FIG. 6.

The controller 16 sends the authentication data to the server 3 to make an inquiry about the authentication at the S11.

The controller 16 then determines whether the inquiry result from the server 3 obtains the authentication or not at the S12. If the authentication succeeds (when the S12 determines YES), the controller requires print server 5 for the user registration. If the authentication fails, (when the S12 determines NO) the job is abandoned at the S13 and the process is terminated.

The print server 5 starts a process upon receipt of a request from the MFP1A at the S14. A search for user information registered in the memory part 14 of the MFP1B at the S15 determines whether the usage information storage area 143 for the user exists or not.

Upon the searching, the controller 16 determines whether the user information has already been registered or not at the S16, that is to determine whether the usage information storage area 143 has already been existed. As no registration (when the S16 determines “none”) means that the user is new, the usage information storage area 143 is generated at the S17, and user information is registered in the user information registration area 141 at the S18. MFP1A is notified of the termination of registration and job process permission, and then moves to the S19 for a process in a MFP1A. The generation of usage information storage area 143 may follow the registration of user information registration area 141.

When the user information is registered (when the S16 determines “exist”), as this means that the user is not new and the usage information storage area 143 has already generated, the process then keeps moving to S19.

The controller 16 of the MFP1A checks the permission of the job process at the S19. If permission is given (when the S19 determines YES), the S20 executes the job process specified by the user. If no permissions are given (when the S19 determines NO), the job reception process is terminated.

Upon the execution of the job process, the controller 16 of the MFP1A notifies the user name and the usage information to be stored in usage information storage area 143 to print server 5.

The print server 5 upon receipt of the notification writes the usage information in the newly generated or an already existing usage information storage area 143 at S21 to renew the contents and terminates the job reception process.

In this embodiment, the usage information is written after the execution of the job process, however, there can be a case wherein the information is written prior to or at some midpoint of the process according to the contents of the usage information.

As for the new user, the usage information storage area 143 with reference to the user information is automatically generated. This eliminates the need for the administrator to conduct the complicated formation process of the usage information storing area for new user.

One embodiment of the present invention has been described, however, the present invention shall not be limited to the above embodiment. For example, authentication server 3 provided at the outside of the MFP1 is used as an authentication part, however, the authentication part may be contained in the MFP1.

Also, memory part 14 having user information registration area 141 and usage information storage area 143 is provided inside of the MFP1, however, the memory part 14 may be provided outside the MFP1 as a database server or included in the external authentication apparatus.

Additionally, the registration area 141 and the usage information storage area 143 may be stored in an identical memory area.

A case where the job and the authentication data is sent from the user terminal 2 to the MFP1 has been described, however, the job and the authentication data may be input from the operation panel 13 of the MFP1.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. A device usage information writing apparatus comprising: a memory having a usage information storage area wherein usage information of a job execution device by a user is stored with reference to the user;
a determination part of an existence of area wherein the existence of the usage information storage area regarding the user is determined concerning the existence at the memory when the user who has succeeded an authentication at an authentication part uses the device;
an area generation part wherein the usage information storage area is generated with reference to the user when the determination part of the existence of area determines that the usage information storage area does not exist after the determination process at the determination part of the existence of the area; and
a writing part in which the device usage information of the user is written in the usage information storage area generated by the area generation part or in an already-existing usage information storage area.

2. The device usage information writing apparatus as recited in claim 1, wherein the job execution device is provided with at least any one of function of copying, scanning, printing, and faxing,
the device usage information comprising a page based counter information or a job based counter information during a use of at least any one of the copying function, the scanning function, the printing function, and the faxing function.

3. The device usage information writing apparatus as recited in claim 1, wherein the memory is shared with a plurality of job execution devices.

4. The device usage information writing apparatus as recited in claim 1, wherein the authentication part exists inside or outside of the usage information writing apparatus.

5. An image forming apparatus having at least any of a copying function, a scanning function, a printing function, and a faxing function comprising:
a memory having the usage information storage area wherein usage information of the image forming apparatus by the user is stored with reference to a user;
a determination part of the existence of area wherein the existence of the usage information storage area regarding the user is determined concerning the existence at the memory of a use by the user who has succeeded an authentication at an authentication part;
an area generation part wherein the usage information storage area is generated with reference to the user when the determination part of the existence of area determines that the usage information storage area does not exist after the determination process at the determination part of the existence of the area; and
a writing part in which the information of the user is written in the usage information storage area generated by the area generation part or in an already-existing usage information storage area.

6. The image forming apparatus as recited in claim 5, wherein the authentication part exists inside or outside of the image forming apparatus.

7. A device system, comprising:
a job execution device;
an authentication apparatus for authenticating a user who uses the device;
a memory having a usage information storage area in which usage information of job execution by the user is stored in association with the user and therein; and
a usage information writing apparatus,
wherein the usage information writing apparatus comprises
a determination part of the existence of the area wherein the existence of the usage information storage area regarding the user is determined concerning the existence at the memory when the user who has succeeded the authentication at the authentication part uses the device;
an area generation part wherein the usage information storage area is generated with reference to the user when the determination part of the existence of the area determined that the usage information storage area does not exist after the determination process at the determination part of the existence of the area; and
a writing part wherein the usage information by the user is written either in the usage information storage area generated by the area generation part or in the already-existing usage information storage area.

8. The device system as recited in claim 7, wherein the job execution device comprises at least any one of a copying function, a scanning function, a printing function, and a faxing function, the usage information writing part is contained in the image forming apparatus.

9. The device system as recited in claim 8, wherein the device usage information is page based counter information and job based counter information when at least any one of the copying function, the scanning function, the printing function, and the faxing function is used.

10. A usage information writing method comprising the steps of:
authenticating the user who uses the job execution device;
determining the existence of the usage information storage area in the memory apparatus regarding the user when the user who has succeeded the authentication uses the device;
generating the usage information storage area with reference to the user when the information storage area is determined as not being existed; and
writing the device usage information of the user into the generated usage information storage area or into the already-existing usage information storage area.

11. The usage information writing method as recited in claim 10, wherein the job execution device comprises at least any one of the copying function, the scanning function, the printing function, and the faxing function.

12. The usage information writing method as recited in claim 11, wherein the device usage information is the page based counter information and the job based counter information when at least any one of the copying function, the scanning function, the printing function, and the faxing function is used.
